(19) United States
(12) Patent Application Publication
(10) Pub. No.: US 2025/0351992 A1
(43) Pub. Date: Nov. 20, 2025

(54) Campfire Cooking Assembly

(71) Applicant: Don Stewart, Haviland, KS (US)

(72) Inventor: Don Stewart, Haviland, KS (US)

(21) Appl. No.: 19/288,028

(22) Filed: Aug. 1, 2025

Related U.S. Application Data
(60) Provisional application No. 63/682,162, filed on Aug. 12, 2024.

(51) Int. Cl. A47J 33/00

(52) U.S. Cl. CPC A47J 33/00

(57) ABSTRACT

A campfire cooking assembly incorporating at least a first burner plate, the assembly further incorporating a column having an upper end, the assembly further incorporating a pin-and-socket fastener for mounting the at least first burner plate upon the column, the pin-and-socket fastener positioning the at least first burner plate at the column's upper end, the assembly further incorporating a plurality of second burner plates which function as floors of a plurality of cooking utensils, the pin-and-socket fastener incorporating a plurality socket halves which are attached to the utensil floors for interchangeable attachments to the upper end of the column.

### CLAIM OF PRIORITY

This non-provisional patent application claims the benefit of and priority from U.S. Provisional Patent Application No. 63/682,162 filed Aug. 12, 2024. The inventor disclosed in said provisional application is the same person as the person who is disclosed as the inventor and applicant of the instant application.

### FIELD OF THE INVENTION

This invention relates to apparatus and assemblies for campfire cooking.

### BACKGROUND OF THE INVENTION

Known assemblies and apparatus for campfire cooking include or present functional deficiencies which cause campfire cooking utensils such as griddles or fry pans to be peripherally positioned near the edge of a campfire where heat may be uneven or insufficient. Such assemblies are also known to ineffectively and inefficiently upwardly conduct heat from the campfire to the undersurface of the cooking utensil.

The instant inventive assembly for campfire cooking solves or ameliorates the above noted defects and deficiencies of known assemblies, and apparatus for campfire cooking by providing cooking utensil support structures which facilitate a central positioning of a supported cooking utensil with respect to a campfire, and which effectively and efficiently conducts heat to central areas at the undersurface of such cooking utensil.

### BRIEF SUMMARY OF THE INVENTION

A first structural component of the instant inventive assembly comprises at least a first upper burner plate element. In a suitable embodiment, the first burner plate is composed of durable steel. The first burner plate is suitably substantially circular, having a diameter between 4½ inches and 7½ inches, such circular configuration providing stable support of an overlying utensil such as a circular fry pan or skillet. To promote even heat distribution, the first burner plate preferably has a substantial thickness, between 5/16″ and ½″, the thickness of such plate allowing it to dually function as a pan or griddle support and as a heat sink.

In an alternate embodiment, the burner plate component may dually or additionally function as a floor component of a campfire cooking utensil such as a fry pan, a cooking pot, a cooking kettle, a coffee pot, a griddle, a wok or cooking grill wherein such grill's floor comprises a matric of bars or expanded metal. The inventive assembly may incorporate several of such utensils, each of which may include a second burner plate component at its floor.

A further structural component of the inventive assembly comprises a support column. In the preferred embodiment, the support column is composed of steel, such column suitably having a circular horizontal cross-sectional shape and having a diameter between ⅝″ and 1″. To avoid rotation of a supported cooking utensil, the support column preferably has a non-circular horizontal cross-sectional profile such as square or hexagon. The vertical length of the column preferably includes a lower end or section which is utilized for ground anchoring, and has an upper section which raises and holds the burner plate at a suitable campfire cooking elevation. The cumulative length of the column's functional upper and lower sections is preferably between 14″ and 20″.

A further structural component of the instant inventive assembly comprises attaching or mounting means which securely interconnect the support column and the burner plate. In a preferred embodiment, the invention's mounting means substantially centrally position the upper end of the support column at the undersurface of the burner plate, such means allowing the support column to extend downwardly therefrom for ground engagement and support. The invention's mounting means are suitably selected from wholly formed joints, welded joints, and helically threaded socket joints. However, in a preferred embodiment, the mounting means comprise a pin-and-socket joint or fastener which may incorporate the upper end of the column as a pin half of such fastener.

In use and operation of the instant inventive assembly, a camper seeking to cook food within a cooking utensil such as a fry pan may initially establish a campfire site. Thereafter, the camper may position the interconnected burner plate and support column components of the assembly substantially centrally within the campfire site. To effect such positioning, the camper may initially place the lower end of the support column in contact with the ground surface of the campfire site at a substantially central location.

Thereafter, the camper may drive the support column downwardly into the ground until the support column's lower ground anchoring section is securely received within and supported by the ground. The invention's column driving step may be effected via percussive downward strikes of hammer or mallet against the upper end of the column or against the upper surface of an attached burner plate.

Thereafter, the camper may prepare and ignite a campfire beneath the burner plate and surrounding the support column. Heat from the campfire is effectively conducted upwardly toward the burner plate by the support column, such conducted heat advantageously warming central locations of the burner plate. To enhance conduction of heat from the campfire to the burner plate, a series of surface area enhancing vanes may be installed at the under surface of the burner plate, such vanes spanning between a side wall of the column or a mounting socket side wall and the undersurface of the burner plate.

Upon campfire heating of the column, vanes, and burner plate components, the camper may place a cooking utensil, such as a frypan containing uncooked bacon, upon the upper surface of the burner plate. Quick and efficient frying of the bacon or other food items is advantageously advanced by both the central position and location of the burner plate and by the support column's central location within the campfire. Conduction of campfire heat by the support column to central locations of the burner plate additionally promotes quick and efficient cooking.

As an alternative to configuration of the burner plate as a utensil supporting disk, the assembly's burner plate component may comprises a floor of a campfire cooking utensil such as a fry pan, a griddle, a cooking pot, a cooking kettle, a coffee pot, a wok, or a cooking grill. In such alternative configuration, the mounting means may comprise a pin-and-socket fastener having a pin half and a socket half, wherein one of such fastener's halves is fixedly attached to the undersurface of such cooking utensil floor, and wherein the other of such fastener's halves is attached to the column's upper end. The installation of such one fastener half upon the undersurface of the selected campfire cooking utensil allows the utensil to be easily and removably fastened at the upper end of the column for campfire cooking. In such embodiment, a plurality of different campfire cooking utensils selected from said group of utensils may be provided, each of such utensils having a matching second fastener half attached to and extending downwardly from the under surface of its utensil floor configured burner plate component. Where the inventive assembly includes such plurality of different campfire cooking utensils, the camper may easily interchange utensils used during a campfire cooking session.

Accordingly, objects of the instant inventive assembly for campfire cooking include the provision of structural components as described above, and include the arrangement and interconnection of those components in the manners described above, the performance of campfire cooking in utilization of such components. Other and further objects, benefits, and advantages of the instant inventive assembly will become known to those skilled in the art upon review of the detailed description which follows, and upon review of the appended drawings.

### BRIEF DESCRIPTION OF DRAWINGS

FIG. 1 is a perspective view of a burner plate, mounting means, and support column combination provided in accordance with the instant inventive assembly.

FIG. 2 presents an alternate configuration of the structure of FIG. 1, the view of FIG. 2 showing a welded juncture mounting means component.

FIG. 3 is a partial sectional view as indicated in FIG. 2.

FIG. 4 presents an alternate configuration of the structures depicted in

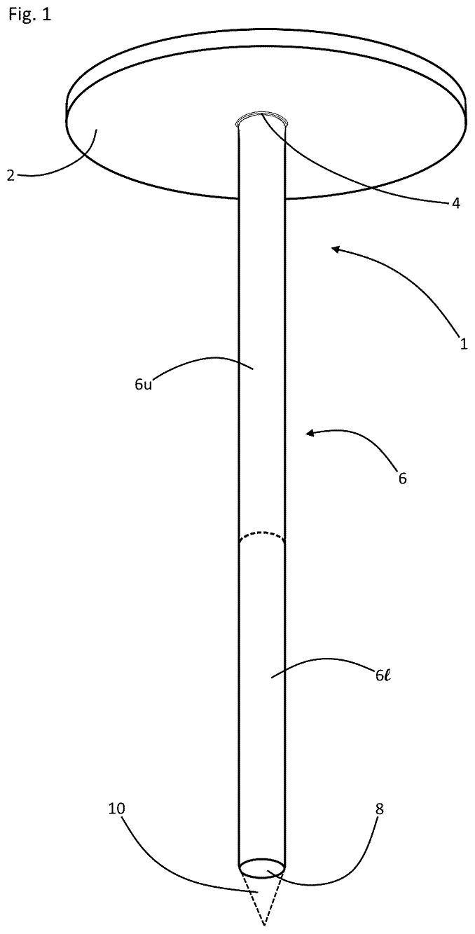

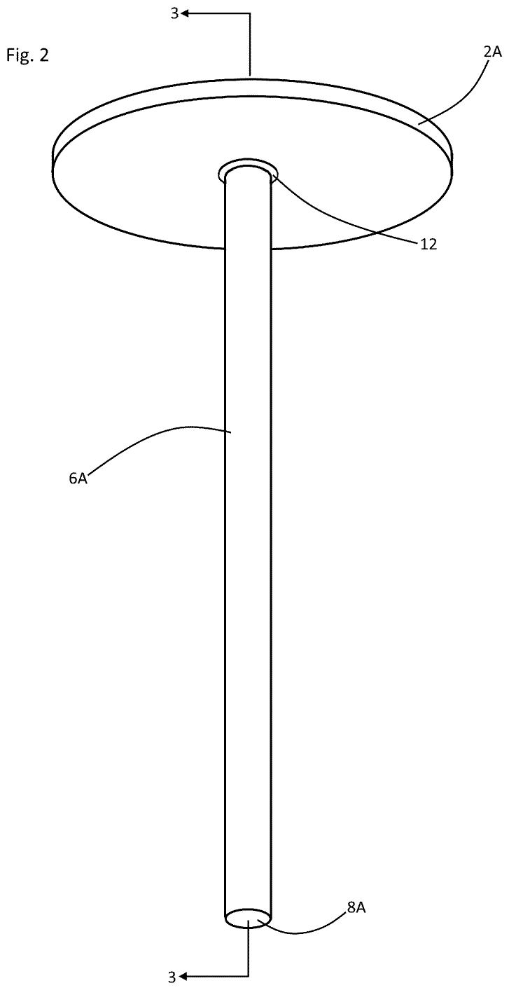

FIGS. 1 and 2.

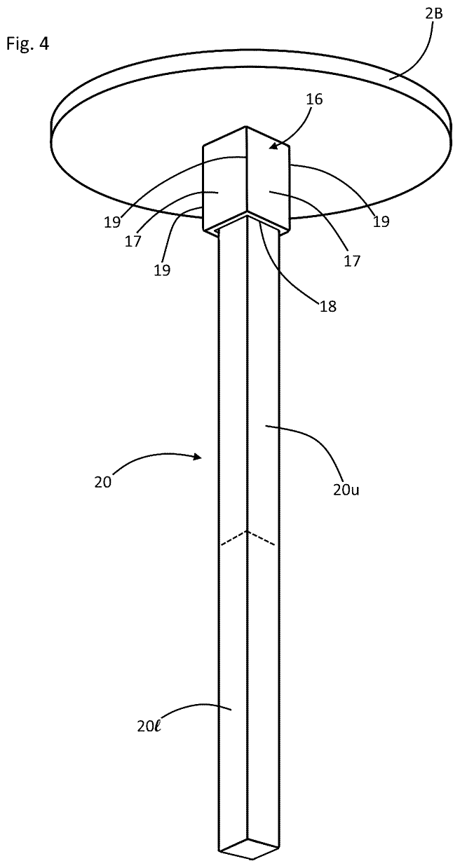

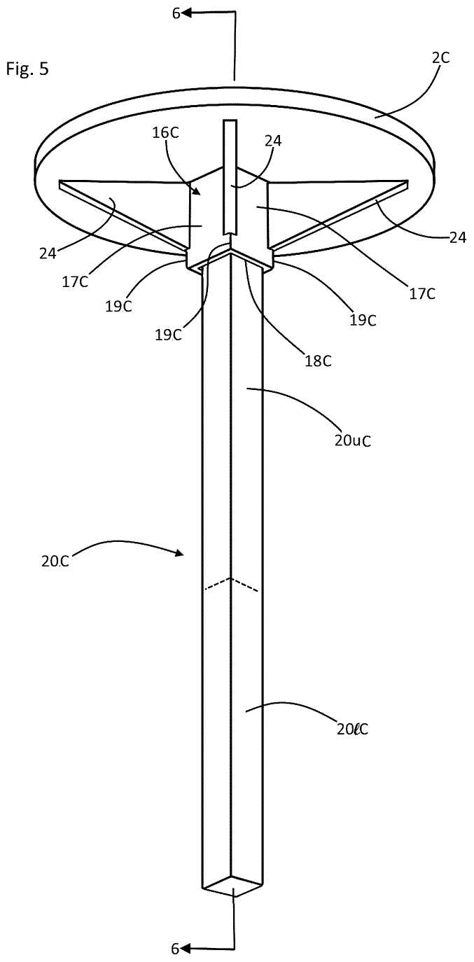

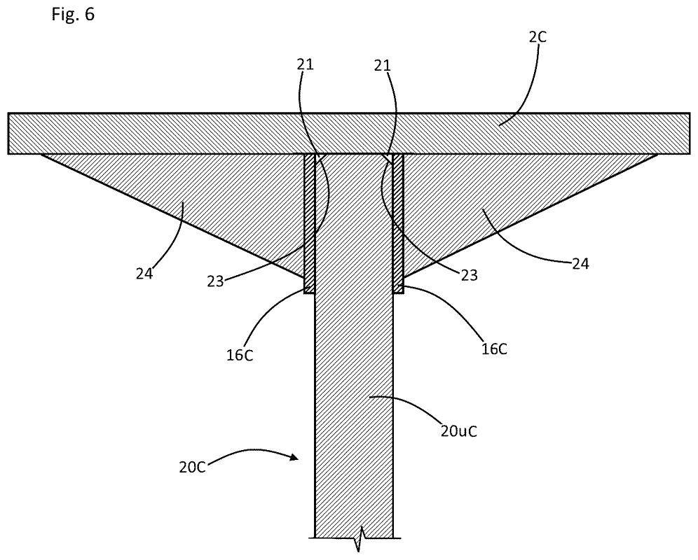

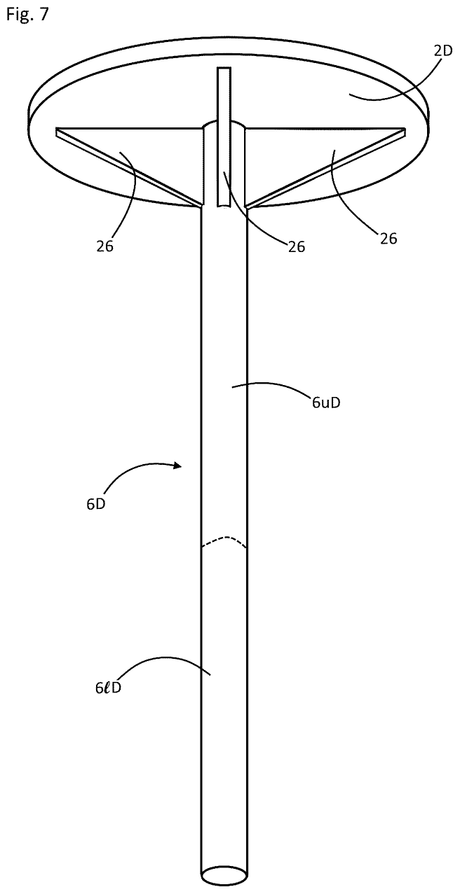

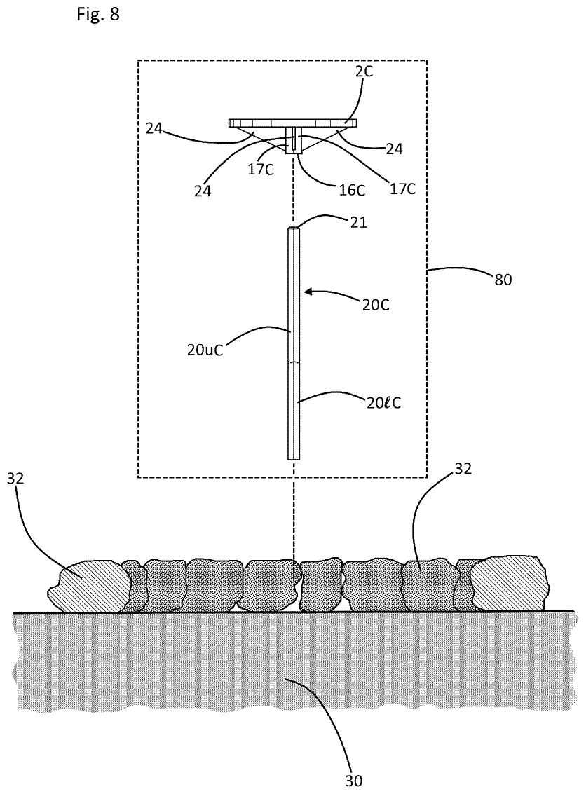

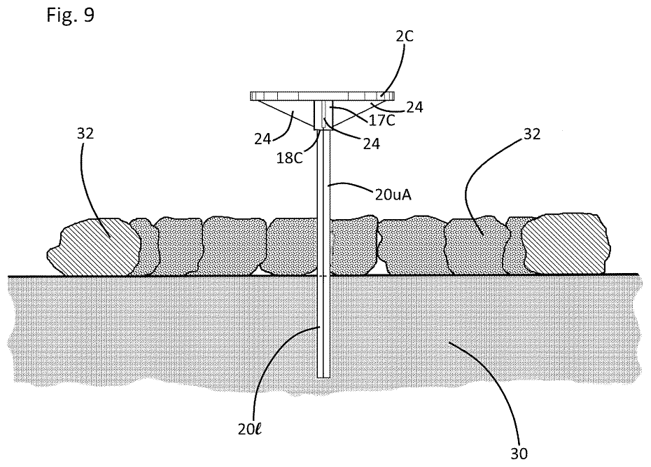

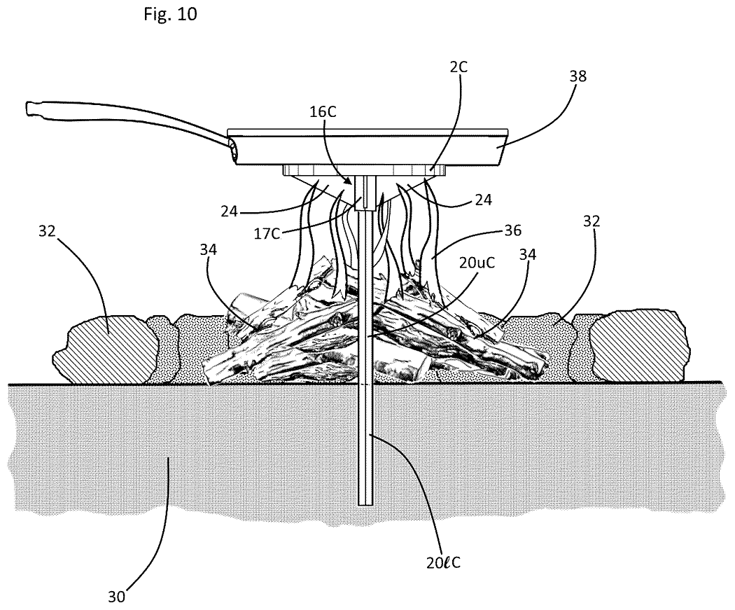

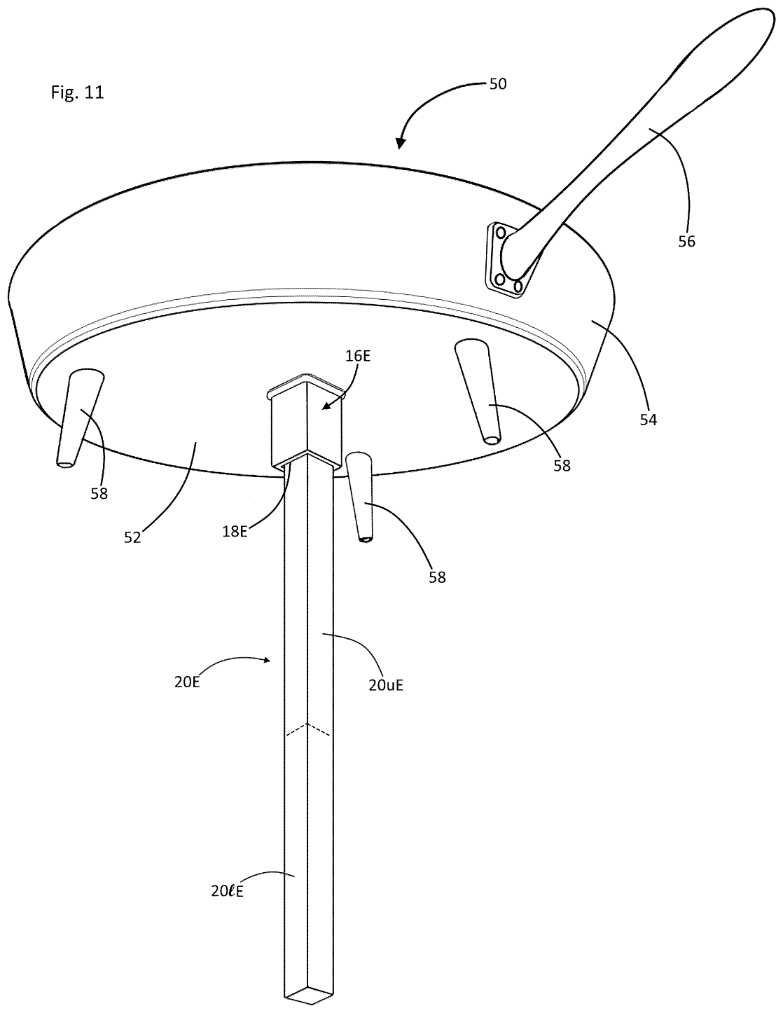

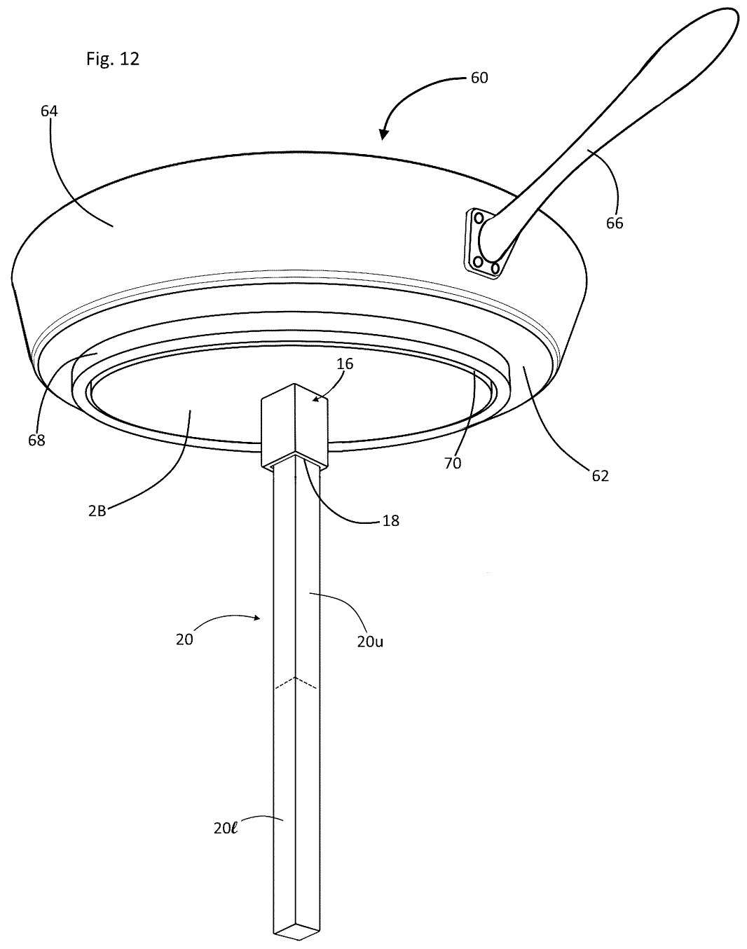

FIG. 5 presents an alternate configuration of the structures presented in FIG. 4.

FIG. 6 is a partial sectional view as indicated in FIG. 5.

FIG. 7 presents an alternate configuration of the structure presented in FIG. 1.

FIG. 8 presents an exploded view of the structures depicted in FIG. 5, the view of FIG. 8 showing components vertically overlying a campfire site.

FIG. 9 is an assembled view of the structures depicted in FIG. 8.

FIG. 10 re-depicts the structures of FIG. 9, the view of FIG. 10 additionally showing an underlying campfire and an overlying frypan.

FIG. 11 presents an alternate configuration of the assembly of FIG. 4, the view showing a burner plate component incorporated into a floor of a cooking utensil.

FIG. 12 re-depicts the structure of FIG. 4, the view showing an alternatively configured fry pan component.

### DETAILED DESCRIPTION OF THE INVENTION

Referring to FIG. 1, a suitable embodiment of the instant inventive assembly for campfire cooking is referred to generally by reference arrow 1. The assembly 1 has a first burner plate 2 and an underlying support column 6, both preferably being composed of durable and heat conducting steel. Mounting means are provided to interconnect the first burner plate 2 and the column 6, such means suitably comprising a wholly formed joint 4. Such joint 4 additionally represents an alternatively provided helically threaded socket mounting means (not depicted within views). The support column 6 includes a lower ground anchoring section 61 and an upper burner riser section 6u. The lower end of the column 6 is suitably configured to present a downwardly facing land which is adapted for hammer driven punching through dense or rocky soil. The column's lower end may alternatively be configured to present a ground lancing point 10.

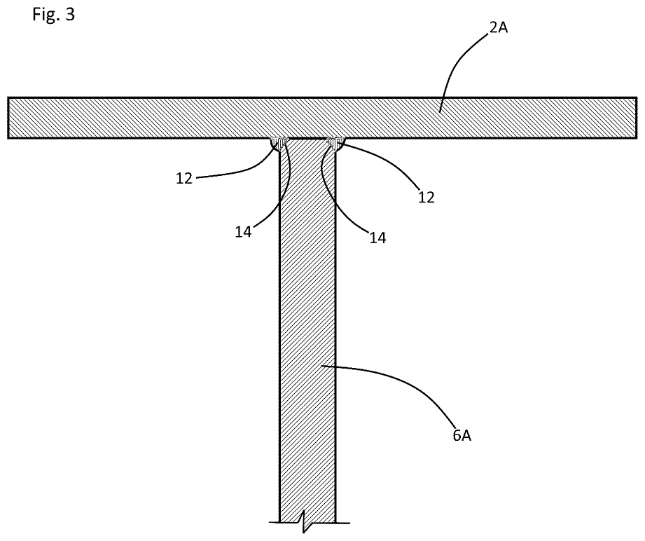

Referring simultaneously to FIGS. 1-3, each structure appearing in FIGS. 2 and 3 having a suffix “A” is configured substantially identically with similarly numbered structures appearing in FIG. 1. In the FIGS. 2 and 3 structural alternative, the invention's mounting means comprise a weld surface enhancing bevel 14 at and about the upper end of the column 6A, in combination with a weld 12.

Referring simultaneously to FIGS. 1-4, each structure appearing in FIG. 4 having a suffix “B” is configured substantially identically with similarly numbered structures appearing in FIGS. 1-3. In the FIG. 4 structural alternative, the mounting means comprise a first downwardly opening socket 16 which opens downwardly and is fixedly attached to the under surface of the first burner plate 2B. The first socket 16 receives the upper end of an upper riser section 20u of a column 20, such column being non-circular having a lower ground anchoring section 201.

In the FIG. 4 embodiment, the interconnected first socket 16 and shaft upper end comprises and functions as a pin-and-socket fastener. While the depicted first socket constitutes an upper half of such fastener, such upper fastener half may suitably alternatively comprise a pin component, the socket half alternatively opening upwardly and being fixedly attached to the column's upper end.

In the FIG. 4 embodiment, the first socket 16 defines a non-circular and downwardly opening void which is fitted for upward receipt of the upper end of the non-circular column 20, such column's upper end constituting a pin half of the assembly's pin-an-socket fastener. In the example of FIG. 4, the socket 16 is square, and is closely fitted for pin-and-socket joint receipt within its void or socket space 18 of the square upper end of the column 20. The non-circular geometry of the mounting means' socket component 16 advantageously resists rotation of the burner plate 2B about a vertical axis during campfire cooking. The exemplary square cross-section of the socket 16 advantageously presents four horizontally facing heat absorbing and heat conducting lands or surfaces 17, such surfaces being divided by four corners 19.

Referring simultaneously to FIGS. 4-6, each structure depicted in FIGS. 5 and 6 which is identified by a reference numeral having a suffix “C” is configured substantially identically with similarly numbered structures appearing in FIG. 4. In the FIGS. 5 and 6 structural alternative, a series of heat absorbing and conducting vanes 24 is provided. Such vanes 24 preferably have radially inner ends in heat conducting contact with column 20C, and have upper ends in heat conducting contact with the undersurface of the first burner plate 2C. To enhance the surface areas of the vanes 24 which are exposed for heat absorption and conduction, the upper dimensions of the vanes 24 are preferably greater than their radially inner dimensions. To further enhance heat absorbing surface areas beneath the first burner plate 20, the radially inner ends of the vanes 24 preferably contact the corners 19C of the socket 16C, such contact points leaving the socket's faces 17C unobstructed and exposed to campfire heat for heat absorption. The vanes 24 advantageously additionally function as reinforcing gussets which horizontally stabilize the first burner plate 2C.

Referring in particular to FIG. 6, the upper end of column 20C preferably presents a peripheral chamfer or bevel 23. Upon execution of hammer strikes against the upper end of the column 20C, the bevel 23 advantageously establishes a metal “mushrooming” space 21 for avoidance of mechanical interference of a hammer strike expanded upper end of column 20C with the inner surfaces of the walls of the first socket 16C.

Referring simultaneously to FIGS. 1 and 7, each structure appearing in FIG. 7 which is identified by a reference numeral having a suffix “D” is configured substantially identically with similarly numbered structures appearing in FIG. 1. The FIG. 7 structural alternative includes a plurality of or series of heat absorbing and conducting vanes 26. Such vanes 26 are preferably structurally and functionally identical to the vanes 24 of the FIGS. 5 and 6 alternative discussed above.

In use and operation of the invention's assembly, referring simultaneously to FIGS. 5, 6, and 8-10, a camper seeking to cook a meal may initially establish a fire ring 32 at a campfire site upon the ground 30. Thereafter, the camper may grasp column 20C in one hand, and may place the column's lower end against the ground at a central location within the campfire site. Thereafter, the camper may wield a hammer or mallet to percussively drive the column 20C vertically downwardly into the ground 30 until the column's lower ground anchoring section 20IC is firmly anchored.

Thereafter, the camper may place the first socket 16C over the upper end of the column 20C, so that the first burner plate 2C is securely raised and positioned above the floor of the campfire site. Alternatively, the camper may hammer downwardly against the upper surface of an assembled burner plate and column combination.

Thereafter, the camper may place kindling and logs 34 about the column's exposed upper riser section 20uC, and the camper may ignite a fire 36.

Heat from the fire 36 is operatively conducted by the column 20C and by the heat absorbing and conducting vanes 24 to central areas of the first burner plate 2C, effectively heating such plate.

Thereafter, the camper may place a cooking utensil such as a fry pan 38 upon the first burner plate 2C. Cooking of food items within the fry pan 38 is enhanced by the column 20C and heat conducting vanes 24 while the non-circular interface between the first socket 16C and the column's upper end resists undesirable rotation of the fry pan.

Upon termination of cooking and upon dousing of the fire 36, the first plate 2C, including its attached first socket 16C, and vanes 24 may be upwardly removed from the upper end of the column 20C. Thereafter, the column 20C may be upwardly extracted from the ground 30. Upon cleaning of components, the detached plate 2C, socket 16C, and vanes 24 combination may be compactly stored in a reduced volume container (not depicted within views), with the column 20C extending in contact with and parallel to the upper face of the first burner plate 2C.

Referring simultaneously to FIGS. 4 and 11, each structure depicted in FIG. 11 which is identified by a reference numeral having a suffix “E” is configured substantially identically with similarly numbered structures appearing in FIGS. 4 and 10. In the FIG. 11 alternative, a floor 52 of a fry pan 50 dually function as a cooking utensil floor and as the assembly's burner plate component, such plate functioning in the same manner as the first burner plates 2, 2A, 2B, 2C, and 2D depicted in FIGS. 1-10.

The fry pan 50 has a peripheral wall 54 and an attached handle 56. In use, a camper may wield and manipulate the fry pan 50 by grasping the handle 56, thereby alternatively lowering and raising the fry pan 50 for attachments and detachments of socket 16E to and from the pin functioning upper end of column 20E. Legs 58 may be advantageously provided, such legs being fixedly attached to and extending downwardly from the fry pan's floor functioning burner plate 52. The downward extensions of the legs 58 preferably equal or exceed that of the socket 16E so that, upon a placement of the fry pan 50 upon a camp table, the fry pan may rest in a stable fashion upon such legs.

The fry pan 50 is intended as being representative of a plurality of different types of campfire cooking utensils including cooking pots, cooking kettles, coffee pots, griddles, woks and cooking grills. Where such cooking utensils are provided as additional components of the inventive assembly, their floors constitute and function as a plurality of second burner plates. Also, where the inventive assembly includes such plurality of different cooking utensils, each their second burner plates is preferably equipped with a second socket which is configured similarly with the first socket 16E, each second socket being fixedly attached to the undersurface of one of such utensils' second burner plates.

Where the instant inventive assembly comprises a combination of a column 2C, a first burner plate 2B, and a plurality of different cooking utensils (represented by fry pan 50) including their incorporated plurality of floor functioning second burner plates 52, the assembly's mounting means preferably comprise a pin-and-socket fastener whose lower pin half comprises the upper end of column 20C and whose upper half comprises multiple interchangeable components consisting of the first socket 16C and the second sockets represented by socket 16E.

Legs similar to legs 58 may be attached to each burner plate among the second floor functioning burner plates 52. Inclusion of such cooking utensil plurality as components of the instant inventive assembly advantageously allows the camper to selectively interchange utensils which are mounted at the top of column 20E. Alternatively, the camper may utilize and interchange commonly configured cooking utensils (i.e. utensils lacking any lower column mounting socket) upon the at least first burner plate 2C.

Referring to FIG. 8, the instant invention suitably additionally comprises a kit which includes a container 80 such as a case, such container housing and storing the column component 20C and at least one burner plate component such as plate 2C. The kit's at least one burner plate component may be configured similarly with the burner plate 2, 2A, 2B, 2C, or 2D of FIGS. 1-10. Alternatively, the kit's at least one burner plate component may comprise a cooking utensil's floor such as the floor 52 of frypan 50 depicted in FIG. 11. Suitably, the kit 80 include several types of cooking utensils, each having a burner plate functioning floor. Each burner plate among the singular or plurality of burner plates which is included in the kit 60 preferably includes a socket, such as socket 16E depicted in FIG. 11, which is fitted for interchangeable receipt of the upper end of the kit's column 20C.

The alternate configuration of the inventive assembly represented in FIG. 12 utilizes the circular steel disk burner plate 2B of the FIG. 4 assembly as a pin half of an overlying pin-and-socket fastener. Such burner plate configured pin half 2B is nestingly received within a downwardly opening void 70 which is formed and defined by a socket 68 which is fixedly attached to and extends downwardly from the floor 62 of a fry pan 60. Similarly with the fry pan 50 of the FIG. 11 assembly, the fry pan 60 has a peripheral wall 64 and a handle 66. Also similarly with the FIG. 11 fry pan 50, the frypan 60 is intended as being representative of other campfire cooking utensils such as cooking pots, cooking kettles, coffee pots, woks and griddles. Where the burner plate 2B includes a different geometric configuration, such as square, both the socket 68 and its downwardly opening void 70 are preferably matchingly configured for secure nesting receipt of such burner plate. While the socket 68 preferably extends continuously about the periphery of the burner plate 2B, such socket may extend intermittently thereabout.

Where the socket 68 has a diameter which, as depicted, spans a major portion of the diameter of the fry pan's floor 62, such socket may itself function as a support member for stabilizing the fry pan 60 upon placement upon a camp table. Accordingly, the socket 68, along with a matching series of similar sockets which may extend from the floors of various different campfire cooking utensils, may advantageously dually function as an upper socket half of the assembly's overlying pin-and-socket fastener and as a utensil stabilizing leg or legs.

Where the fry pan 60 is mounted upon the burner plate 2 or 2A of the FIGS. 1-3 configuration, the completed assembly's pin-and-socket fastener exclusively consists of a burner plate configuration pin half and an at least first or series of socket halves 68. In such configuration, the burner plate which is attached via pin-and-socket mounting means comprises the floor of the utensil. In the alternative FIG. 12 configuration, a vertical series of or upper and lower pin-and-socket fasteners is presented. In such vertical series, the upper or overlying pin-and-socket fastener comprises the burner plate configured pin half 2B and the socket or socket series 68, and such series' lower or underling pin and socket fastener comprising the upper end of column 20 in combination with socket 16.

In the FIG. 12 configuration of the assembly, the plate 2B may alternatively exclusively function as the assembly's burner plate, allowing various conventionally configured campfire cooking utensils to rest thereon.

While the principles of the invention have been made clear in the above illustrative embodiments, those skilled in the art may make modifications to the structure, arrangement, portions, and components, of the invention without departing from those principles. Accordingly, it is intended that the description and drawings be interpreted as illustrative and not in the limiting sense, and that the invention be given a scope commensurate with the appended claims.

1. A campfire cooking assembly comprising:
a. A least a first burner plate;
b. A column having an upper end; and
c. Means for mounting the at least first burner plate upon the column, said means positioning the at least first burner plate at the column's upper end.

2. The campfire cooking assembly of claim 1, wherein the means for mounting the at least first burner plate upon the column comprises a pin-and-socket fastener.

3. The campfire cooking assembly of claim 2, wherein the pin-and-socket fastener comprises a pin half and an at least first socket half, the at least first socket half being fixedly attached to and extending downwardly from the at least first burner plate.

4. The campfire cooking assembly of claim 3, wherein each of the pin-and-socket fastener's halves has a non-circular cross-sectional profile.

5. The campfire cooking assembly of claim 4, further comprising a plurality of vanes, each vane spanning between the at least first burner plate and the pin-and-socket fastener.

6. The campfire cooking assembly of claim 5, wherein the column has a blunt lower end.

7. The campfire cooking assembly of claim 3, further comprising a plurality of second burner plates and a plurality of cooking utensils, wherein each cooking utensil has a floor comprising one of the second burner plates, wherein the pin-and-socket fastener further comprises a plurality of second socket halves, and wherein each second socket half is fixedly attached to and extends downwardly from one of the second burner plates.

8. The campfire cooking assembly of claim 7, wherein each burner plate among the at least first and plurality of second burner plates is selected from a group consisting of circular metal plates and cooking utensil floors.

9. The campfire cooking assembly of claim 8, wherein each cooking utensil among the plurality of cooking utensils is selected from a group consisting of fry pans, cooking pots, cooking kettles, coffee pots, griddles, cooking grills, and woks.

10. The campfire cooking assembly of claim 9, further comprising pluralities of legs, each of the leg pluralities being fixedly attached to one of the cooking utensil floors.

11. The campfire cooking assembly of claim 10, wherein each leg among the pluralities of legs has a downward extension, wherein each socket half among the pluralities of second socket halves has a downward extension, and wherein each of the legs' downward extensions is greater than or equal to that of one of the second socket halves.
